(19) United States
(12) Patent Application Publication
(10) Pub. No.: US 2026/0302303 A1
(43) Pub. Date: Oct. 1, 2026

(54) FUEL CELL SYSTEM

(71) Applicant: HONDA MOTOR CO., LTD., TOKYO (JP)

(72) Inventor: Shota FUJIMURA, WAKO-SHI (JP)

(21) Appl. No.: 19/629,437

(22) Filed: Mar. 26, 2026

(30) Foreign Application Priority Data
Mar. 28, 2025 (JP) 2025-056459

(51) Int. Cl. H01M 8/2475; H01M 8/0438

(52) U.S. Cl. CPC H01M 8/2475; H01M 8/04388

(57) ABSTRACT

A fuel cell system includes a stack case that houses a fuel cell stack, a hydrogen-system auxiliary device section for supplying hydrogen, a hydrogen-capture cover covering the hydrogen-system auxiliary device section, a hydrogen sensor attached to the hydrogen-capture cover, and a ventilation unit for discharging hydrogen leaking from the fuel cell stack. The hydrogen-capture cover covers the upper part of the hydrogen-system auxiliary device section and the ventilation unit.

### CROSS-REFERENCE TO RELATED APPLICATIONS

This application is based upon and claims the benefit of priority from Japanese Patent Application No. 2025-056459 filed on Mar. 28, 2025, the contents of which are incorporated herein by reference.

### BACKGROUND OF THE INVENTION

### Field of the Invention

The present disclosure relates to a fuel cell system.

### Description of the Related Art

In recent years, research and development have been conducted on fuel cells that contribute to energy efficiency in order to ensure that more people have access to affordable, reliable, sustainable and modern energy.

### SUMMARY OF THE INVENTION

As disclosed in JP 2024-089946 A, since hydrogen is a gas lighter than air, a hydrogen sensor for detecting hydrogen leakage is usually disposed at the uppermost portion of a hydrogen retention portion. However, when a structure (a vehicle frame, a cabin, or the like) is placedabove the hydrogen retention portion, there is a problem that the influence on the peripheral layout, such as recessing the structure or lowering the position of the fuel cell system itself becomes large in order to dispose the hydrogen sensor at the uppermost portion.

On the other hand, in order to avoid the arrangement of the hydrogen sensor at the uppermost portion, it is conceivable to arrange the hydrogen sensor at each of the assumed leakage points of a plurality of hydrogen retention portions. In this case, it is necessary to arrange a plurality of hydrogen sensors or to provide a partition wall covering all the hydrogen retention portions, which causes a problem of a decrease in the arrangement space forother auxiliary devices and an increase in cost and weight.

In order to solve the above problem, an object of the present disclosure is to achieve a reduction in the number of hydrogen sensors to be disposed while preventing the hydrogen sensor from bulging to the uppermost portion of the fuel cell system. The present invention thus contributes to energy efficiency.

An aspect of the present disclosure is a fuel cell system including a stack case that houses a fuel cell stack, a hydrogen-system auxiliary device section that is provided adjacent to a first sidewall of the stack case and in which auxiliary devices configured to supply hydrogen to the fuel cell stack is collectively disposed, a hydrogen-capture cover that is attached to the first sidewall and houses at least a partof the hydrogen-system auxiliary device section, a hydrogen sensor that is attached to the hydrogen-capture cover, and a ventilation unit configured to discharge hydrogen that has leaked from the fuel cell stack, wherein the hydrogen-capture cover covers the hydrogen-system auxiliary device section and the ventilation unit from above.

According to the present disclosure, the hydrogen sensor is prevented from bulging out to the uppermost portion of the fuel cell system, and the number of hydrogen sensors to be disposed is suppressed.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a fuel cell system according to a first embodiment;

FIG. 2 is a perspective view of the fuel cell system from which a hydrogen-capture cover of FIG. 1 is removed;

FIG. 3 is a perspective view of the hydrogen-capture cover shown in FIG. 1;

FIG. 4 is an enlarged cross-sectional view of a main part taken along line IV-IV of FIG. 3;

FIG. 5 is an enlarged cross-sectional view of a main part taken along line V-V of FIG. 1; and

FIG. 6 is a schematic configuration diagram of a fuel cell system according to asecond embodiment.

### DETAILED DESCRIPTION OF THE INVENTION

### First Embodiment

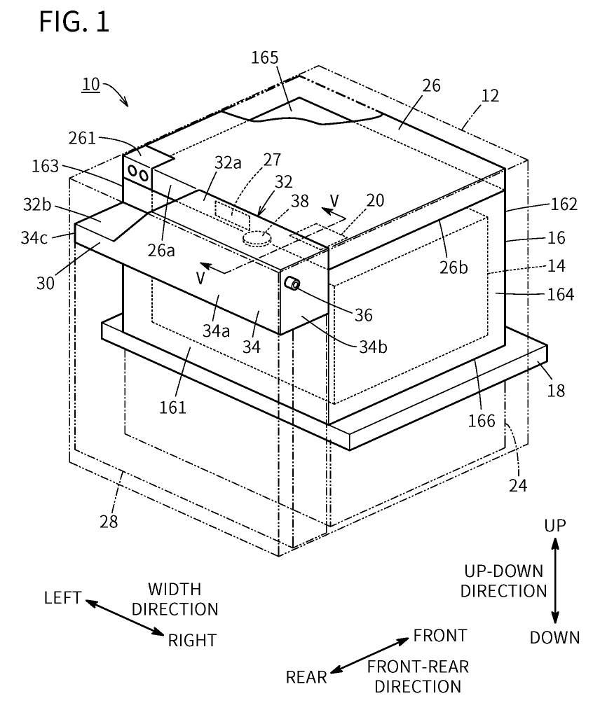

A fuel cell system 10 of the present embodiment shown in FIG. 1 is mounted on a moving object such as a truck, a trailer head, a civil engineering/construction machine, an aircraft, a ship, and the like, or is used as a stationary power source or the like of a facility that consumes a large amount of electrical power such as a data center. In order to facilitate mounting of the fuel cell system 10 on a wide range of devices, all components including auxiliary devices, pipes, and wires are housed in a rectangular parallelepiped region called an envelope 12. The arrangement of the auxiliary devices of the fuel cell system 10 is restricted by the envelope 12.

The fuel cell system 10 includes a stack case 16 that houses a fuel cell stack 14, a support frame 18 that supports the stack case 16, and the auxiliary devices. The stack case 16 is a box-shaped container having a substantially rectangular parallelepiped shape extending in the front-rear direction, the width direction, and the up-down direction. The front-rear direction, the width direction, and the up-down direction are mutually orthogonal. The front-rear direction and the width direction are terms used to indicate the arrangement relationship or shapes of the respective members of the fuel cell system 10, and do not limit the arrangement direction of the fuel cell system 10. The up-down direction substantially coincides with the vertical direction.

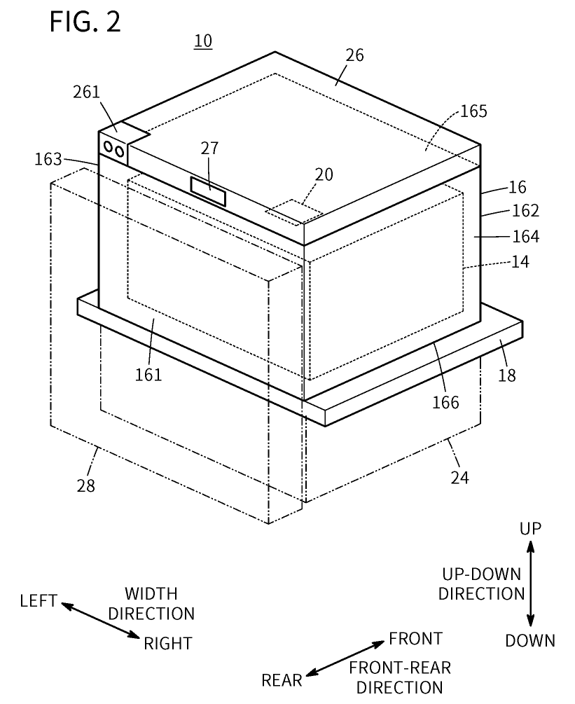

As shown in FIGS. 1 and 2, the stack case 16 has a first sidewall 161, a second sidewall 162, a third sidewall 163, a fourth sidewall 164, an upper wall 165, and a bottom wall 166. The first sidewall 161 is positioned rearward in the front-rear direction, and the second sidewall 162 is positioned forward in the front-rear direction. The third sidewall 163 is positioned on the left side in the width direction, and the fourth sidewall 164 is positioned on the right side in the width direction.

The stack case 16 accommodates the fuel cell stack 14 therein, thereby limiting the location from which hydrogen leaked from the fuel cell stack 14 flows out. Inside the stack case 16, hydrogen that has leaked from the fuel cell stack 14 and its peripheral pipes, flow paths, and the like moves upward due to the difference in relative density with air. Hydrogen accumulates in the upper portion of the stack case 16 in this manner is discharged from the stack case 16 through an opening 20 inthe upper wall 165 of the stack case 16. The opening 20 communicates with the electrical component case 26. The hydrogen gas also flows into the electrical component case 26 through a gap around a wire extending from a power output terminal of the fuel cell stack 14.

As shown in FIGS. 1 and 2, the stack case 16 is disposed on the support frame 18. The support frame 18 is a substantially flat plate-shaped member, and is formed in a rectangular shape when viewed from above. The support frame 18 has a larger width than the stack case 16. A fixing mechanism (not shown) for fixing the stack case 16 to the support frame 18 is provided on a side portion of the support frame 18 in the width direction. In addition to the stack case 16, some auxiliary devices and the like are fixed to the support frame 18. The support frame 18 may also be used as a fixing portion for attaching the fuel cell system 10 to an external device.

The fuel cell system 10 includes hydrogen-system auxiliary devices, air-system auxiliary devices, an electrical system, and cooling water piping as auxiliary devices.

The air-system auxiliary devices include an air pump that compresses air, a heat exchanger that cools the compressed air, a humidifier that humidifies the compressed air, air piping for guiding compressed air, exhaust piping for discharging cathode off-gas, and a plurality of valves provided in each of the air piping and exhaust piping. In order to prevent the air piping and the exhaust piping from being elongated, most of the air-system auxiliary devices are collectively arranged in anair-system auxiliary device section 24 below the support frame 18.

Cooling water is supplied to a cooling water flow path inside the fuel cell stack 14 through the cooling water piping. The cooling water piping is mostly arranged below the support frame 18.

The electrical system includes a high-voltage power circuit, a low-voltage power circuit, a controller, a connector 261, a terminal block, and the like. The high-voltage power circuit constitutes a power supply device that converts the electrical power generated by the fuel cell stack 14 into a predetermined voltage and outputs the predetermined voltage to a high-voltage power line of an external device. The low-voltage power circuit constitutes a power supply device that receives direct current from a low-voltage power line of an external device and supplies the direct current power of a relatively low voltage such as 12V, 24V, 48V, or the like, which is necessary for driving the controller, the valves, the sensors, and the like. The high-voltage power circuit and the low-voltage power circuit include heat-generating components, and are therefore provided on the upper wall 165 of the stack case 16. Some of the electrical components including the high-voltage power circuit and the low-voltage power circuit are housed in an electrical component case 26 above the stack case 16.

As shown in FIGS. 1, 2, and 5, the electrical component case 26 is attached on top of the upper wall 165 of the stack case 16. The electrical component case 26 includes an opening 26b at the lower end, and the lower end 26b is blocked by the upper wall 165 of the stack case 16 to form a sealed space. The electrical component case 26 includes a seal member at a portion in contact with the stack case 16, and can prevent dust from entering the inside. The electrical component case 26 is provided with a ventilation unit 27 for discharging the hydrogen gas leaked from the stack case 16.

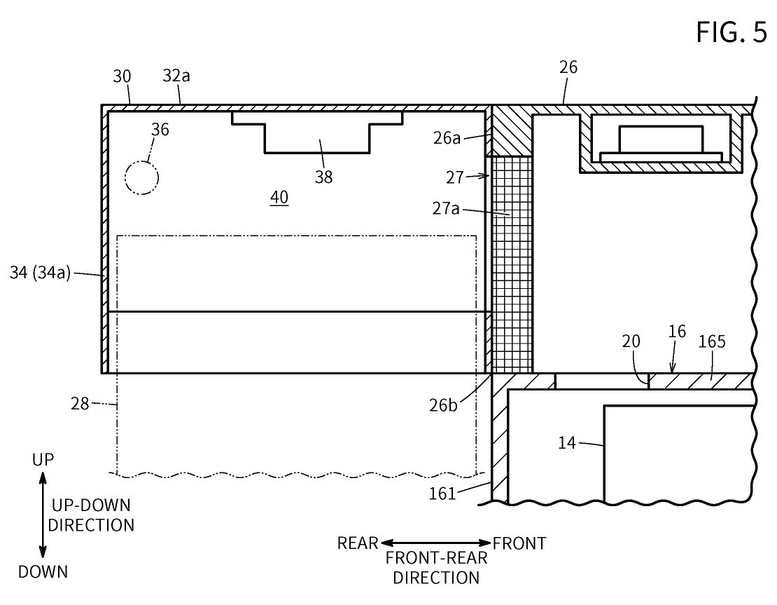

The ventilation unit 27 is provided on the rear end wall 26a of the electrical component case 26 that is positioned rearward in the front-rear direction. The ventilation unit 27 is positioned above the first sidewall 161 of the stack case 16 and releases hydrogen rearward. The ventilation unit 27 is arranged to be shifted rightward from the center in the width direction. The ventilation unit 27 is covered from above by a hydrogen-capture cover 30 to be described later. The ventilation unit 27 is positioned below the upper end of the hydrogen-capture cover 30. As shown in FIG. 5, the ventilation unit 27 may be provided with a filter 27a for preventing water and dust from entering the inside of the electrical component case 26.

As shown in FIG. 1, the connector 261 of the electrical system is provided on the rear left side of the electrical component case 26. Cables connected to the high-voltage power line and the low-voltage power line of the external devices are connected to the connector 261. A protrusion constituting a heat sink and an unillustrated housing recess for housing a terminal block are formed on the upper portion of the electrical component case 26. The terminal block is arranged in the housing recess of the electrical component case 26. A control device (FCECU) and a switchboard are disposed, for example, on a side of the second sidewall 162 that is farthest from ahydrogen-system auxiliary device section 28.

The hydrogen-system auxiliary devices include, for example, a high-pressure hydrogen pipe, a hydrogen circulation pipe, a gas-liquid separator, a parge pipe, a hydrogen pump (for example, a jet pump type ejector), an injector, and a plurality of valves. In order to prevent the hydrogen circulation pipe from being elongated, most of the hydrogen-system auxiliary devices are collectively arranged in the hydrogen-system auxiliary device section 28 on the lateral side (rear side) of the first sidewall 161 of the stack case 16.

In the hydrogen-system auxiliary devices, hydrogen leaks little by little through pipes, valves, outer walls of the auxiliary devices, and the like. In addition, leakage of hydrogen increases due to defects such as looseness of connecting portions of the pipes and valves, or cracks due to deterioration of outer walls. The fuel cell system 10 of the present embodiment includes thehydrogen-capture cover 30 in order to efficiently detect leakage of hydrogen from the hydrogen-system auxiliary devices.

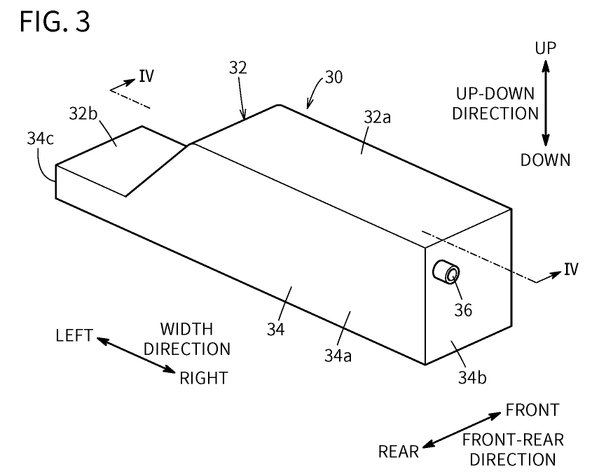

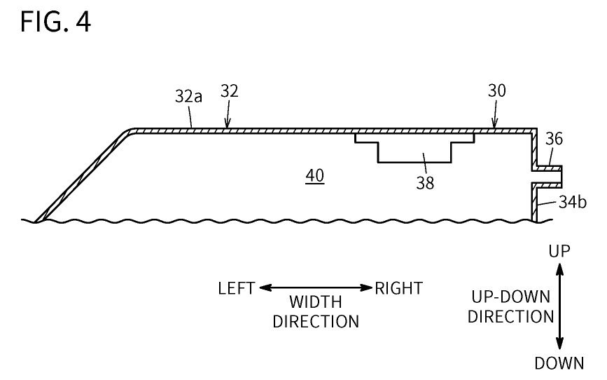

As shown in FIGS. 1, 3, 4, and 5, the hydrogen-capture cover 30 is attached to the stack case 16. The hydrogen-capture cover 30 is disposed so as to cover the hydrogen-system auxiliary device section 28 and the ventilation unit 27 of the electrical component case 26 from above. The hydrogen-capture cover 30 includes an upper end wall 32, a sidewall 34, and a discharge hole 36. A hydrogen sensor 38 is attached to the hydrogen-capture cover 30.

The upper end wall 32 defines an upper part of the hydrogen-capture cover 30. The upper end wall 32 includes an uppermost portion 32a and a recessed portion 32b that is recessed downward partially in the width direction. The uppermost portion 32a is the highest portion of the hydrogen-capture cover 30, and positioned above the ventilation unit 27. The uppermost portion 32a is positioned in the vicinity of the upper end of the envelope 12. The uppermost portion 32a is positioned at substantially the same height as the upper end of the electrical component case 26, and abuts against the rear end wall 26a of the electrical component case 26.

The connector 261 and the distribution cable to be connected to the high-voltage power circuit and the low-voltage power circuit are disposed in the recessed portion 32b. The recessed portion 32b is positioned lower than the uppermost portion 32a. The recessed portion 32b is continuous with the uppermost portion 32a via a sloped portion. The recessed portion 32b is positioned on the left side in the width direction. The hydrogen that has reached the recessed portion 32b moves to the uppermost portion 32a through the sloped portion and comes into contact with the hydrogen sensor 38.

The sidewall 34 extends downward from the peripheral edge of the upper end wall 32. The sidewall 34 includes a rear sidewall 34a, a right sidewall 34b, and a left sidewall 34c. The rear sidewall 34a is positioned at the rear end of the hydrogen-capture cover 30. The rear sidewall 34a is positioned in the vicinity of the rear end of the envelope 12. The right sidewall 34b is positioned at the right end of the hydrogen-capture cover 30 in the width direction. The right sidewall 34b is positioned in the vicinity of the right end of the envelope 12.

The left sidewall 34c is positioned at the left end of the hydrogen-capture cover 30 in the width direction. The left sidewall 34c is positioned in the vicinity of the left end of the envelope 12. The sidewall 34 includes an opening at a position facing the ventilation unit 27 so as not to block the ventilation unit 27. The sidewall 34 extending downward from the peripheral edge of the upper end wall 32 of the hydrogen-capture cover 30 forms a hydrogen-capture chamber 40 beneath the upper end wall 32. The lower end of the sidewall 34 extends farther downward than the upper end of the hydrogen-system auxiliary device section 28, and the upper end side of the hydrogen-system auxiliary device section 28 is partially housed in the hydrogen-capture chamber 40.

The hydrogen-capture chamber 40 is open downward. If the amount of hydrogen accumulated in the hydrogen-capture chamber 40 is so small, the hydrogen diffuses into the atmosphere and is diluted before being detected by the hydrogen sensor 38. If hydrogen leaks at or above a predetermined flow rate, the leaked hydrogen remains within the hydrogen-capture chamber 40 surrounded by the upper end wall 32 and the sidewall 34, and accumulates at a relatively high concentration around the hydrogen sensor 38.

Hydrogen captured in the hydrogen-capture chamber 40 is discharged to the outside through the discharge hole 36. The discharge hole 36 is provided at a position spaced downward from the upper end wall 32. Thus, a region where hydrogen tends to accumulate is formed in theportion above the discharge hole 36 in the hydrogen-capture chamber 40. That is, hydrogen can be accumulated around the hydrogen sensor 38, and even when the amount of leakage of hydrogen is relatively small, the hydrogen sensor 38 can detect the leakage.

The discharge hole 36 is formed in the right sidewall 34b away from the recessed portion 32b. The hydrogen accumulates at the recessed portion 32b flows toward the vicinity of the right sidewall 34b owing to the difference in height between the recessed portion 32b and the upper end wall 32, and is guided toward the hydrogen sensor 38. In a case where the concentration of the accumulating hydrogen reaches a predetermined concentration or more within the hydrogen-capture chamber 40, the hydrogen is discharged to the outside through the discharge hole 36. By arranging the discharge hole 36 on the right sidewall 34b, hydrogen flowing from the recessed portion 32b passes by the hydrogen sensor 38 on its way to the discharge hole 36, thereby allowing hydrogen to be detected efficiently.

The discharge hole 36 is disposed at a position that is more rearward away from the first sidewall 161 than the hydrogen sensor 38 when viewed from above. In the case where hydrogen has leaked from the ventilation unit 27 positioned above the first sidewall 161, the leaked hydrogen is discharged from the hydrogen-capture chamber 40 of the hydrogen-capture cover 30 through the discharge hole 36 when the hydrogen concentration becomes equal to or higher than the predetermined concentration. The discharge hole 36 prevents hydrogen at or above the predetermined concentration from staying in the hydrogen-capture chamber 40 for a long period of time. The hydrogen sensor 38 positioned above the discharge hole 36 efficiently detects hydrogen on the way from the ventilation unit 27 to the discharge hole 36.

The hydrogen sensor 38 is mounted on the lower surface of the uppermost portion 32a of the upper end wall 32. The hydrogen sensor 38 bulges downward from the uppermost portion 32a without protruding upward from the upper end wall 32. Therefore, even in the case where the upper end of the envelope 12 restricts the space to such an extent that upward installation of the hydrogen sensor 38 is not feasible, the hydrogen sensor 38 can nevertheless be attached.

The hydrogen sensor 38 is disposed in the vicinity of the right sidewall 34b at a position adjacent to the discharge hole 36 in the width direction, and at least a detection portion for detecting hydrogen is arranged above the discharge hole 36. Further, the hydrogen sensor 38 is positioned further above the upper end of the ventilation unit 27. Thus, the hydrogen leaking from the hydrogen-system auxiliary device section 28 and the ventilation unit 27 is reliably guided to the hydrogen sensor 38.

The fuel cell system 10 of the present embodiment is configured as described above. In the fuel cell system 10, hydrogen leaking from any part of the hydrogen-system auxiliary device section 28 and the ventilation unit 27 flows upward and accumulates in the hydrogen-capture cover 30. The hydrogen captured by the hydrogen-capture cover 30 is accumulated in the upper part of the hydrogen-capture chamber 40.

Thus, the fuel cell system 10 of the present embodiment can efficiently detect usingthe single hydrogen sensor 38 hydrogen leaking from hydrogen retention portions distributed in the respective portions of the hydrogen-system auxiliary devices, the fuel cell stack 14, and the like. As a result, compared to the case where a plurality of hydrogen sensors 38 are provided, space for arranging the hydrogen sensors 38 can be reduced, the degree of freedom of the arrangement layout of the auxiliary devices is increased, and the auxiliary devices can be mounted more compactly in the fuel cell system 10 of the present embodiment.

In the above example, hydrogen leaking from the fuel cell stack 14 is discharged to the hydrogen-capture cover 30 via the electrical component case 26, but the present embodiment is not limited to this configuration. The stack case 16 and the electrical component case 26 may be isolated from each other so that hydrogen cannot flow therebetween. In this case, the ventilation unit 27 is formed in the first sidewall 161 of the stack case 16, and the hydrogen leaked from the fuel cell stack 14 is discharged through the ventilation unit 27 provided in the first sidewall 161 of the stack case 16. Even in this case, the hydrogen-capture cover 30 can capture hydrogen leaking from the ventilation unit 27 and guide the hydrogen to the vicinity of the hydrogen sensor 38.

### Second Embodiment

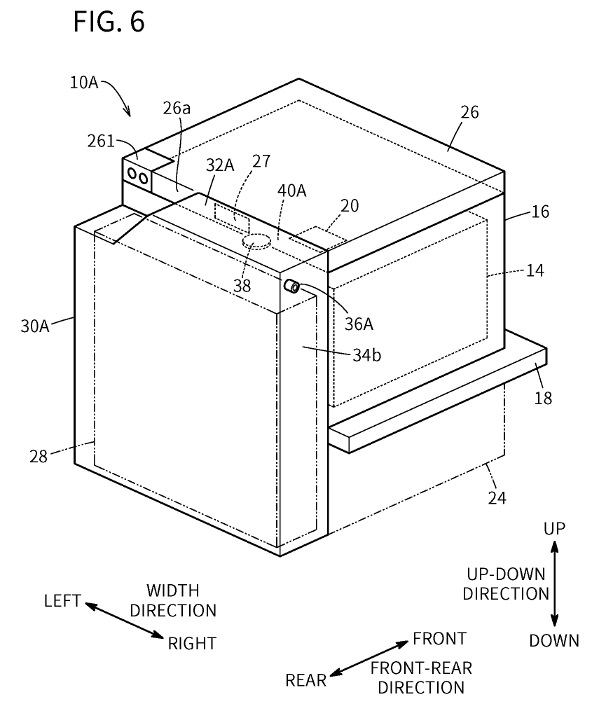

As shown in FIG. 6, the fuel cell system 10A of the present embodiment includes a hydrogen-capture cover 30A disposed so as to cover the hydrogen-system auxiliary device section 28 entirely. In the fuel cell system 10A of the present embodiment, the same constituent elements as those corresponding to the fuel cell system 10 described with reference to FIGS. 1 to 5 are designated by the same reference numerals, and detailed description of such features is omitted.

The hydrogen-capture cover 30A is a box-shaped sealed container, and accommodates at least a part of the hydrogen-system auxiliary devices. The hydrogen-capture cover 30A is arranged on the rear side of the first sidewall 161 of the stack case 16. The upper end of the hydrogen-capture cover 30A is positioned on the rear side of the electrical component case 26, and the lower end of the hydrogen-capture cover 30A of the hydrogen-capture cover is positioned on the rear side of the air-system auxiliary device section 24. The hydrogen-capture cover 30A includes through holes through which the hydrogen circulation pipe and the high-pressure hydrogen pipe pass. The hydrogen-capture cover 30A is in communication with the inside of the electrical component case 26 through a communication hole provided at a portion corresponding to the ventilation unit 27 of the electrical component case 26. Anupper end wall 32A of the hydrogen-capture cover 30A covers the upper part of the ventilation unit 27.

A discharge hole 36A is provided at the upper part of the right sidewall 34b of the hydrogen-capture cover 30A. The discharge hole 36A is arranged at a positioned spaced downward from the upper end wall 32A, thereby forming, at the upper end portion of the hydrogen-capture cover 30A, a hydrogen-capture chamber 40A in which hydrogen is accumulated.

A hydrogen sensor 38 is attached to the inner surface of the upper end wall 32A of the hydrogen-capture cover 30A. The attachment position of the hydrogen sensor 38 is substantially the same as the attachment position of the hydrogen sensor 38 described with reference to FIGS. 1 to 5.

In the fuel cell system 10A of the present embodiment, hydrogen leaking from any part of the hydrogen-system auxiliary device section 28 accumulates in the hydrogen-capture chamber 40A at the upper part of the hydrogen-collecting cover 30A. The hydrogen leaked from the fuel cell stack 14 flows into the inside of the hydrogen-capture cover 30A through the ventilation unit 27 of the electrical component case 26, and is captured in the hydrogen-capture chamber 40A. As a result, the leaked hydrogen reliably accumulates in the vicinity of the hydrogen sensor 38, and therefore, in the fuel cell system 10A of the present embodiment, the leakage of hydrogen occurred in various hydrogen retention portions can be reliably detected by the single hydrogen sensor 38.

The following supplementary notes are further disclosed in relation to the above embodiment.

### Supplementary Note 1

The fuel cell system (10, 10A) of the present disclosure includes thestack case (16) that accommodatesthe fuel cell stack (14), thehydrogen-system auxiliary device section (28) that is provided adjacent to thefirst sidewall (161) of the stack case and in which auxiliary devices configured to supply hydrogen to the fuel cell stack is collectively disposed, thehydrogen-capture cover (30, 30A) that is attached to the first sidewall and accommodatesat least a partof the hydrogen-system auxiliary device section, thehydrogen sensor (38) that is attached to the hydrogen-capture cover, and theventilation unit (27) configured to discharge hydrogen that has leaked from the fuel cell stack, wherein the hydrogen-capture cover covers the hydrogen-system auxiliary device section and the ventilation unit from above.

The fuel cell system described above can suppress the number of hydrogen sensors to be disposed while preventing the hydrogen sensor from bulging upward.

### Supplementary Note 2

In the fuel cell system according to Supplementary Note 1, the hydrogen sensor may be arranged on theupper end wall (32, 32A) of the hydrogen-capture cover, the hydrogen-capture cover may include thehydrogen-capture chamber (40, 40A) configured to allow hydrogen to accumulate under the hydrogen sensor, the hydrogen-capture cover may include, at thelower part of the hydrogen-capture chamber, at least one discharge hole (36, 36A) configured to discharge hydrogen accumulates in the hydrogen-capture chamber, and the discharge hole may be positioned farther from the first sidewall than the hydrogen sensor when the hydrogen-capture cover is viewed from above. In this fuel cell system, the hydrogen flowing out from the ventilation unit passes near the hydrogen sensor to be discharged from the discharge hole, and therefore the hydrogen flowing out from the ventilation unit can be reliably detected by the hydrogen sensor.

### Supplementary Note 3

In the fuel cell system according to Supplementary Note 2, the hydrogen sensor may be arranged inside the hydrogen-capture cover, and the discharge hole may be provided as a single discharge hole and arranged at a level lower than the hydrogen sensor. In this fuel cell system, since hydrogen can be captured at the upper portion of the hydrogen-capture cover, even when the hydrogen sensor is not bulged upward, the hydrogen sensor can be reliably brought into contact with the leaked hydrogen.

### Supplementary Note 4

In the fuel cell system according to Supplementary Note 1, the hydrogen-capture cover may accommodate at least a part of the hydrogen-system auxiliary device section and may be attached to the stack case. In this fuel cell system, the hydrogen-capture cover accommodates the hydrogen-system auxiliary device section, so that hydrogen can reach the hydrogen sensor without diffusing, and therefore, even a smaller amount of hydrogen leakage can be reliably detected.

### Supplementary Note 5

The fuel cell system according to any one of Supplementary Notes 1 to 4 may further include theelectrical component case (26) configured to accommodate electrical components and provided on theupper wall (165) of the stack case, wherein the upper wall of the stack case includes theopening (26b) in communication with the electrical component case, and the ventilation unit may be provided on a rear end wall (26a) of the electrical component case above the first sidewall. The fuel cell system can detect hydrogen flowing out from the fuel cell stack through the electrical component case.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, these embodiments can also be implemented in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell system comprising:
a stack case that accommodatesa fuel cell stack;
a hydrogen-system auxiliary device section that is provided adjacent to a first sidewall of the stack case and in which auxiliary devices configured to supply hydrogen to the fuel cell stack is collectively disposed;
a hydrogen-capture cover that is attached to the first sidewall and accommodatesat least a partof the hydrogen-system auxiliary device section;
a hydrogen sensor that is attached to the hydrogen-capture cover; and
a ventilation unit configured to discharge hydrogen that has leaked from the fuel cell stack, wherein
the hydrogen-capture cover covers the hydrogen-system auxiliary device section and the ventilation unit from above.

2. The fuel cell system according to claim 1, wherein
the hydrogen sensor is arranged on an upper end wall of the hydrogen-capture cover,
the hydrogen-capture cover includes a hydrogen-capture chamber configured to allow hydrogen to accumulate under the hydrogen sensor,
the hydrogen-capture cover includes, at a lower part of the hydrogen-capture chamber, at least one discharge hole configured to discharge hydrogen accumulates in the hydrogen-capture chamber, and
the discharge hole is positioned farther from the first sidewall than the hydrogen sensor when the hydrogen-capture cover is viewed from above.

3. The fuel cell system according to claim 2, wherein
the hydrogen sensor may be arranged inside the hydrogen-capture cover, and
the discharge hole is provided as a single discharge hole and arranged at a level lower than the hydrogen sensor.

4. The fuel cell system according to claim 1, whereinthe hydrogen-capture cover accommodates at least a part of the hydrogen-system auxiliary device section and is attached to the stack case.

5. The fuel cell system according to claim 1, further comprising:
an electrical component case configured to accommodate electrical components and provided on an upper wall of the stack case,
wherein the upper wall of the stack case includes an opening in communication with the electrical component case, and
the ventilation unit is provided on a rear end wall of the electrical component case above the first sidewall.
